(19) United States
(12) Patent Application Publication
(10) Pub. No.: US 2015/0321185 A1
(43) Pub. Date: Nov. 12, 2015

(54) EXHAUST GAS PURIFICATION CATALYST WITH HIGH RESISTANCE TO SILICON POISONING

(71) Applicant: NIKKI-UNIVERSAL CO., LTD., Shinagawa-ku, Tokyo (JP)

(72) Inventors: Shinichi Ueno, Kanagawa (JP); Takanobu Sakurai, Kanagawa (JP); Toshiya Nashida, Kanagawa (JP)

(21) Appl. No.: 14/655,590

(22) PCT Filed: Dec. 25, 2013
(86) PCT No.: PCT/JP2013/084563

§ 371 Date: Jun. 25, 2015

(30) Foreign Application Priority Data
Dec. 25, 2012 (JP) 2012-280822

(51) Int. Cl. B01J 29/76; B01J 23/89; B01J 23/42; B01J 35/00; B01J 35/04

(52) U.S. Cl. CPC B01J 29/7615; B01J 35/0006; B01J 35/04; B01J 23/42; B01J 23/8906

(57) ABSTRACT

A catalyst composition of excellent silicon-resistant performance, and a catalyst containing the catalyst composition are provided. The catalyst composition is one for purifying an exhaust gas containing an organic compound, the catalyst composition comprising at least one inorganic oxide (component 1) selected from the group consisting of alumina, zirconia, titania, silica, ceria, and ceria-zirconia, each having a noble metal supported thereon; β zeolite (component 2) having supported thereon at least one metal selected from the group consisting of Fe, Cu, Co and Ni; and a Pt—Fe composite oxide (component 3).

### TECHNICAL FIELD

This invention relates to a catalyst composition for purifying an exhaust gas containing an organic compound, and a catalyst containing the catalyst composition. More specifically, the present invention relates to a catalyst composition with excellent silicon-resistant performance, and a catalyst containing the catalyst composition.

### BACKGROUND ART

In a wide variety of fields such as printing, painting, coating, surface treatment of coating films, electronic materials, plastics, glass, ceramics, etc., and silicone manufacturing, organic compounds, for example, benzene, toluene, methyl ethyl ketone, and ethyl acetate are used as solvents or cleaning agents, and they are partly emitted as exhaust gases. Among these organic compounds are toxic compounds, and some of them present causes of offensive odors or air pollution. Hence, there is need to purify exhaust gases containing such organic compounds (VOC or volatile organic compounds). Noble metal supported catalysts, which oxidize organic compounds to remove them, have so far been used as exhaust gas purification catalysts.

These exhaust gases often contain organosilicon compounds such as silicones, thermal decomposition products of silicones, silanes, and siloxanes. For example, silicone compounds excellent in heat resistance and water resistance are put to various uses, for example, additives to paints or PET resins. Silicon compounds attributed to the silicone compounds, sulfur compounds or phosphorus compounds may also be contained in exhaust gases from plants, or furnace gases in drawing furnaces for PET film production.

When noble metal supported catalysts are used for the treatment of exhaust gases or PET drawing furnace gases, which contain organic compounds or organosilicon compounds, silicon poisons the noble metal to lower the catalytic activity. Since the organosilicon compound itself is hazardous, moreover, its removal is also desired.

Organosilicon compounds are reported to decompose thermally at temperatures in the neighborhood of 200° C. to form sticky substances such as resins, and these sticky substances reportedly cause clogging (see, for example, Patent Document 1).

Catalysts having noble metals supported on zeolites are reported for the treatment of exhaust gases containing silicon compounds (for example, Patent Document 2). The present applicant filed patent applications on catalyst compositions incorporating HY type zeolites with high acidity, in order to improve the silicon resistance of alumina, titanium oxide or zirconia catalysts having noble metals supported thereon and using carriers less expensive than zeolites (see Patent Documents 3, 4 and 5).

It is industrially desirable to use a carrier cheaper than zeolite, and there is also a report that a catalyst having platinum supported on titanium oxide, in which pores with a pore diameter of 100 Å or less occupy 15% or less of the total pore volume, can suppress catalyst deterioration due to organosilicon compounds (see, for example, Patent Document 6).

The use of a Pd/ZrO₂ catalyst or a Pd/TiO₂ catalyst for the purification of a methane-containing exhaust gas is publicly known (see, for example, Patent Document 7). The Pd/ZrO₂ catalyst or Pd/TiO₂ catalyst, however, poses the problem that its activity rapidly decreases when used for the treatment of an exhaust gas containing organosilicon compounds.

For the treatment of an exhaust gas containing silicon compounds, a catalyst having activity maintained during a longer period of service is desired and sought for.

### CITATION LIST

### Patent Documents

Patent Document 1: JP-A-10-267249 ([0003], [0004])

Patent Document 2: JP-A-2003-290626 (Claim 1, [0006])

Patent Document 3: WO2005/094991 ([Claim 1], [0008])

Patent Document 4: JP-A-2006-314867 ([Claim 1], [0013])

Patent Document 5: W02009-125829 ([Claim 1], [0010-0013])

Patent Document 6: JP-A-2003-71285 ([Claim 1], [0004])

Patent Document 7: JP-A-11-319559 ([Claim 1], Comparative Example 5)

### SUMMARY OF INVENTION

### Technical Problem

An object of the present invention is to provide a catalyst composition which retains high activity for a long period, with a decline in performance over time being suppressed, in purifying an exhaust gas or a PET drawing furnace gas containing organic compounds or organosilicon compounds; and a catalyst containing the catalyst composition.

A specific object of the present invention is to provide a hydrocarbon-containing gas purification catalyst having high durability and improved in the resistance, to silicon poisoning, of a noble metal supported alumina catalyst, a noble metal supported zirconia catalyst, a noble metal supported ceria-zirconia catalyst, a noble metal supported ceria catalyst and/or a noble metal supported titanium oxide catalyst.

A more specific object of the present invention is to provide a catalyst which, in the purification of an exhaust gas or a PET drawing furnace gas containing organic compounds or silicon compounds; retains high activity for a long time despite a decrease in the amount of a noble metal used in the catalyst, can suppress a decline in performance over time, can prolong catalyst life, and shows high purification performance.

### Solution to Problem

The present inventors have found that the deterioration over time of catalytic activity is suppressed by using a catalyst composition comprising at least one inorganic oxide (component 1) selected from the group consisting of alumina, zirconia, titania, silica, ceria, and ceria-zirconia, each having a noble metal supported thereon; β zeolite (component 2) having supported thereon at least one metal (metal M) selected from the group consisting of Fe, Cu, Co and Ni; and a composite oxide of Pt and Fe (hereinafter referred to as “Pt—Fe composite oxide”; component 3). This finding has led them to accomplish the present invention. According to the present invention, high activity in decomposing hydrocarbons is exhibited, and the amount of an expensive noble metal used can be cut down.

That is, the present invention has aspects as shown below.

(1) A catalyst composition for purifying an exhaust gas containing an organic compound, the catalyst composition comprising at least one inorganic oxide (component 1) selected from the group consisting of alumina, zirconia, titania, silica, ceria, and ceria-zirconia, each having a noble metal supported thereon; β zeolite (component 2) having supported thereon at least one metal selected from the group consisting of Fe, Cu, Co and Ni; and a Pt—Fe composite oxide (component 3).

(2) The catalyst composition according to (1) above, wherein the ratio of the atomic number of Fe to the total atomic number of Pt and Fe of the Pt—Fe composite oxide, namely, [Fe]/([Pt]+[Fe]), is 0.17 to 0.3.

(3) The catalyst composition according to (1) or (2) above, wherein the noble metal is Pt, and the ratio of the atomic number of the Pt not forming the Pt—Fe composite oxide to the total atomic number of the Pt not forming the Pt—Fe composite oxide and the Pt of the Pt—Fe composite oxide is 0.50 to 0.95.

(4) The catalyst composition according to (3) above, wherein the Pt has a valence of 0 or 2, and the Pt has an average particle diameter of 0.8 to 25 nm.

(5) The catalyst composition according to (3) or (4) above, wherein the content of the Pt is 0.1% by weight to 10% by weight based on the component 1.

(6) The catalyst composition according to any one of (1) to (5) above, wherein the weight ratio between the component 1 and the component 2 is 1:9 to 9:1, and the SiO₂/Al₂O₃ molar ratio of the β zeolite as the component 2 is 5 or more, but 100 or less.

(7) The catalyst composition according to any one of (1) to (6) above, further comprising a binder.

(8) The catalyst composition according to (1) above, wherein the noble metal supported on the component 1 is Pt, Pd, Rh, Ir, Ru, Os, an alloy thereof, or a mixture thereof.

(9) A catalyst for purifying an exhaust gas containing an organic compound, the catalyst comprising a catalyst support; and a catalyst layer formed on the catalyst support and containing the catalyst composition according to any one of (1) to (8) above.

### Advantageous Effects of Invention

According to the catalyst of the present invention, the following prominent effects are achieved:

(1) When used for the treatment of an exhaust gas containing silicon compounds, the catalyst undergoes small changes in catalyst performance over time, and shows silicon resistance with an improved catalyst life as compared with conventional catalysts.

(2) The amount of the expensive noble metal used in the catalyst can be decreased.

(3) Moreover, performance in resisting (being durable against) sulfur poisoning can be enhanced.

### BRIEF DESCRIPTION OF DRAWINGS

FIG. 1 shows the results of an organosilicon compound poisoning test on the catalyst composition of the present invention containing Pt/Al₂O₃+Feβ+Pt—Fe composite oxide.

FIG. 2 shows the results of the organosilicon compound poisoning test on the catalyst composition of the present invention containing Pt/Al₂O₃+Feβ+Pt—Fe composite oxide, with the Fe/(Pt+Fe) atomic ratio of the Pt—Fe composite oxide being changed.

FIG. 3 shows the results of the organosilicon compound poisoning test on the catalyst composition of the present invention containing Pt/Al₂O₃+Feβ+Pt—Fe composite oxide, with the ratio of the atomic number of the Pt not forming the Pt—Fe composite oxide to the total atomic number of the Pt not forming the Pt—Fe composite oxide and the Pt of the Pt—Fe composite oxide being changed.

FIG. 4 shows the results of the organosilicon compound poisoning test on the catalyst composition of the present invention containing Pt/Al₂O₃+Feβ+Pt—Fe composite oxide, with the Fe/(Pt+Fe) atomic ratio of the Pt—Fe composite oxide being fixed at 0.25 and the Pt average particle diameter being changed.

FIG. 5 shows the results of an H₂S poisoning test on the catalyst composition of the present invention containing Pt/Al₂O₃+Feβ+Pt—Fe composite oxide.

### DESCRIPTION OF EMBODIMENTS

The catalyst composition of the present invention contains, as essential components, at least one inorganic oxide (component 1) selected from the group consisting of alumina, zirconia, titania, silica, ceria, and ceria-zirconia, each having a noble metal supported thereon; β zeolite (component 2) having supported thereon at least one metal (may be referred to hereinafter as metal M) selected from the group consisting of Fe, Cu, Co and Ni; and a Pt—Fe composite oxide (component 3).

Concretely, the catalyst composition of the present invention is a uniform mixture having the above-mentioned component 1, component 2 and component 3 as its essential components.

The components 1 to 3 will be described in detail below.

Component 1

The alumina (Al₂O₃) usable as the component 1 of the catalyst according to the present invention is active alumina in general use as a catalyst carrier, such as γ-alumina or δ-alumina, especially γ-alumina. The preferred alumina used is active alumina having a specific surface area of 10 m²/g or more, preferably 50 to 300 m²/g, and is in the form of particles having an average particle diameter of 0.1 μm to 100 more preferably 0.1 to 50 μm, but the alumina may be in any shape. As such alumina, there can be used commercially available products, for example, aluminas marketed by Nikki-Universal Co., Ltd. (product names: NST-5 and NSA20-3X6) and aluminas of SUMITOMO CHEMICAL CO., LTD. (product names: e.g., NK-124).

The zirconium oxide usable as the component 1 (chemical formula: ZrO₂, may be referred to as zirconia) is preferably a porous ZrO₂ powder generally on the market whether it is of a monoclinic system, a tetragonal system or a cubic system. Its specific surface area is an important factor for supporting platinum, as an active metal, in a highly dispersed state, and for enhancing contact with a gas to be treated. Thus, the zirconium oxide preferably has a specific surface area of 5 m²/g or more, and a porous one having a specific surface area of 10 to 150 m²/g is more preferred. As for its average particle diameter, a particulate one with an average particle diameter of 0.1 μm to 100 μm, more preferably 0.1 to 50 μm, is preferred for increased contact with the gas. As zirconium oxide meeting these conditions, there can be used, for example, commercially available products such as the RC series of products from DAIICHI KIGENSO KAGAKU KOGYO CO., LTD. and the XZO series of products from Nippon Light Metal Co., Ltd. Composite type ZrO₂ products can also be used, for example, ZrO₂.nCeO₂, ZrO₂.nSiO₂, and ZrO₂.nSO₄.

As the component 1, ceria (CeO₂) or ceria-zirconia (a composite oxide composed of ceria and zirconia; hereinafter referred to as CeO₂.ZrO₂) can also be used. The component 1 may be one or more members selected from the group consisting of composite oxides containing CeO₂, ZrO₂ and an oxide of at least one of La, Y, Pr and Nd. The catalyst of the present invention, which contains CeO₂ or CeO₂.ZrO₂, has high decomposition activity on PET oligomers, forms little carbon, shows high durability, and is thus particularly effective in preventing the contamination of the furnace. The specific surface area is an important factor for supporting a noble metal, such as platinum as an active metal, in a highly dispersed state, and for enhancing contact with the gas to be treated. Thus, the ceria or ceria-zirconia preferably has a specific surface area of 5 m²/g or more, and a porous one having a specific surface area of 10 to 150 m²/g is more preferred. Its average particle diameter is preferably 0.1 μm to 100 μm, and more preferably in the range of 0.1 μm to 50 μm, in order to increase contact with the gas. As the above-mentioned ceria or ceria-zirconia, commercially available products manufactured by DAIICHI KIGENSO KAGAKU KOGYO CO., LTD., for example, can be used.

As the titanium oxide (may hereinafter be represented by TiO₂ and called titania) usable as the component 1 in the present invention, anatase type or rutile type titanium oxide can be used. In particular, a porous one is preferred, and that of the anatase type is preferred. Anatase type TiO₂ can be produced by the wet chemical method (chloride or sulfate) or by flame hydrolysis of titanium tetrachloride, and usually has a specific surface area larger than 50 m²/g.

The aforementioned Al₂O₃, ZrO₂, CeO₂, CeO₂.ZrO₂, and TiO₂ are each in the form of particles from the viewpoints of enhancing contact with the coexistent zeolite particles, forming a homogeneous and smooth catalyst layer on the support, and preventing cracking of the catalyst layer. It is preferred to use any of them having a particle diameter in the range of 0.05 μm to 100 μm. Large particles with a particle diameter exceeding 100 μm are pulverized with a ball mill or the like, and used as a material. The shape of the above Al₂O₃ particles, ZrO₂ particles, CeO₂ particles, CeO₂.ZrO₂ particles, and TiO₂ particles is preferably spherical from the aspects of miscibility with the zeolite particles used in combination, and enhanced contact between the particles. However, this is not limitative. In the present invention, unless otherwise specified, the particle diameter refers to the average particle diameter of secondary particles measured by the laser method, and the shape refers to the shape of secondary particles.

The Al₂O₃, ZrO₂, CeO₂, CeO₂.ZrO₂, and/or TiO₂ particles, used as the component 1 in the catalyst of the present invention, have supported thereon a noble metal, namely, at least one or two members selected from Pt, Pd, Rh, Ir, Ru, Os, an alloy thereof, and a mixture thereof. To produce a catalyst superior in low-temperature activity, the noble metal is preferably Pt, Pd, an alloy thereof, or a mixture thereof. Pt is particularly preferred and, for use in a high-temperature region, it is particularly preferred to use Rh or use Rh and other noble metal in combination.

To support the noble metal on the catalyst, various publicly known methods including the impregnation method and the washcoating method can be employed.

The source of the noble metal may be noble metal particles or a noble metal compound, but a water-soluble salt of the noble metal is preferred. Examples of the preferred noble metal source are nitrates, chlorides, ammonium salts, and ammine complexes of the noble metal. Concrete examples are chloroplatinic acid, palladium nitrate, rhodium chloride, and an aqueous nitric acid solution of dinitrodiaminoplatinum. These noble metal sources may be used alone or in combination. As a means of supporting Pt, for example, ZrO₂ particles are impregnated with an aqueous solution of the above noble metal compound, e.g., Pt(NH₃)₂(NO₂)₂, then dried at 100 to 180° C., calcined at 400 to 600° C., and reduced to obtain ZrO₂ particles having Pt supported thereon (component 1). The method of reduction is, for example, heating in a hydrogen-containing atmosphere, or a liquid phase reaction using a reducing agent such as hydrazine.

There are no particular restrictions on the amount of the noble metal in the catalyst, and this amount is determined by the shape of the catalyst such as the thickness of the catalyst layer formed on the catalyst support, the type of the organic compound in the exhaust gas, and the reaction conditions such as the reaction temperature and SV. Typically, the amount of the noble metal for 1 m² of the catalyst layer is in the range of 0.05 to 2.0 g, although it is dependent on the type of the support, for example, the number of the cells of the honeycomb. The amount of the noble metal less than the above range results in the insufficient removal of the organic compound in the exhaust gas, while the amount in excess of the above range is not economical. The amount of the noble metal in the component 1 is preferably in the range of 0.1 to 10% by weight based on the weight of the component 1. A more preferred amount of the noble metal in the component 1 is in the range of 0.5 to 8% by weight, and the most preferred amount is in the range of 1 to 5% by weight.

It is more preferred to use, as the component 1 in the catalyst of the present invention, alumina, zirconia, or ceria-zirconia which acts to oxidize and decompose the exhaust gas and serves to disperse Pt highly.

If the noble metal supported on the component 1 is Pt, the supported Pt preferably has a valence of 0 or 2, and has an average particle diameter of 0.5 to 25 nm, more preferably 2 to 20 nm. There is a correlation between the particle diameter of Pt and the silicon resistance of the catalyst, probably because of the interaction of the component 1 with the transition metal-supported zeolite as the component 2 in the catalyst of the present invention, to be described later, in the configuration of the catalyst of the present invention. The silicon resistance can be improved by setting the average particle diameter of Pt at 0.5 to 25 nm, more preferably 2 to 20 nm. Its value lower than this range, or in excess of this range, would lessen the silicon resistance. The average particle diameter and valence of Pt can be determined by the analysis of XAFS (X-ray absorption fine structure) or the CO adsorption method.

The proportion of the component 1 which can be incorporated in the catalyst composition is 10 to 90% by weight, preferably 20 to 80% by weight, more preferably 30 to 70% by weight, based on the weight of the catalyst composition.

Component 2

Component 2 for use in the catalyst composition of the present invention is preferably β zeolite having supported thereon at least one metal (to be referred to hereinafter as metal M) selected from the group consisting of Fe, Cu, Co and Ni. The SiO₂/Al₂O₃ molar ratio of the zeolite used in the present invention is preferably 5 or more, but 100 or less. To improve the silicon resistance, the SiO₂/Al₂O₃ molar ratio of the zeolite used in the present invention is 1 or more, preferably 2 or more, more preferably 5 or more, but 100 or less, preferably 50 or less, more preferably 30 or less. Although not wishing to be bound by any theory, it is believed that the β zeolite having supported thereon at least one metal selected from the group consisting of Fe, Co, Ni, and Cu acts to oxidize and decompose the exhaust gas and oxidize and decompose the organosilicon compounds.

The zeolite used in the present invention is preferably in the form of particles, and its average particle diameter is preferably in the range of 0.5 to 300 μm, from the viewpoints of enhancing contact with the Al₂O₃, ZrO₂, CeO₂, CeO₂.ZrO₂, or TiO₂ particles used in combination, forming a homogeneous and smooth catalyst layer on the support, and preventing cracking of the catalyst layer. The shape of the zeolite particles is preferably spherical from the aspects of miscibility with the Al₂O₃, ZrO₂, CeO₂, CeO₂.ZrO₂, or TiO₂ particles used in combination, and enhanced contact between the particles. However, this is not limitative. As the β zeolite having the metal M supported thereon, commercially available products such as Fe-BEA-25 produced by Clariant Catalysts (Japan) K.K., for example, can be used.

In addition to the β zeolite, there may be used its mixture with artificial zeolite, natural zeolite, Y type zeolite, X type zeolite, A type zeolite, MFI, mordenite or ferrierite. To improve the silicon resistance of the catalyst, zeolite with high acidity can be used. Examples of the zeolite with high acidity are HY type, X type, and A type zeolites. The acid amount of the zeolite herein is indicated as the amount of NH₃ desorption at 160 to 550° C. in the ammonia adsorption method, and expressed in millimoles (mmol) of desorbed NH₃ per gram of the zeolite. The acid amount of the zeolite used in the present invention is 0.4 mmol/g or more, preferably 0.5 mmol/g or more, more preferably 0.6 mmol/g or more. Although the upper limit of the acid amount is not fixed, zeolite with an acid amount of 1.5 mmol/g or less, preferably 1.2 mmol/g or less is easily available. If a mixture of various kinds is used as the zeolite, the acid amount is found from the weight average of the acid amounts of the respective zeolites.

The proportion of the component 2 which can be incorporated into the catalyst composition is 10 to 90% by weight, preferably 20 to 80% by weight, more preferably 30 to 70% by weight, based on the weight of the catalyst composition.

Component 3

The present invention is characterized in that the Pt—Fe composite oxide is included as the component 3 used in the catalyst composition of the present invention. The Pt—Fe composite oxide used as the component 3 preferably fulfills the condition that the ratio of the atomic number of Fe to the total atomic number of Pt and Fe of the Pt—Fe composite oxide, namely, [Fe]/([Pt]+[Fe]), has a value of 0.2 to 0.3. Its examples include, but not limited to, Fe₂Pt₈O₁₁, Fe₁₀Pt₃₀O₄₅, and Fe₆Pt₁₄O₂₃, containing trivalent Fe.

If the ratio of the atomic number is lower than or higher than the above range, the silicon resistance declines. The preferred Pt—Fe composite oxide as the component 3 is such that the ratio of the atomic number of Fe to the total atomic number of Pt and Fe of the Pt—Fe composite oxide (i.e., [Fe]/([Pt]+[Fe])) is 0.2 to 0.3. By adopting such a Pt—Fe composite oxide, the durability and silicon resistance of the catalyst to catalyst poisoning can be improved. The element ratio can be determined by XAFS (X-ray absorption fine structure) analysis. The atomic ratio (i.e., the ratio of the atomic number) of the Pt—Fe composite oxide, [Fe]/([Pt]+[Fe]), can be adjusted to any value by setting the raw materials in the desired proportions. For example, the adjustment can be made by mixing an aqueous solution of a platinum compound and an aqueous solution of an iron compound at a predetermined atomic ratio, drying the mixture, and calcining it (will be described in detail in the item “Preparation of Pt—Fe composite oxide” in the Examples to be described later).

The source of platinum may be platinum particles or a platinum compound, but a water-soluble salt of platinum is preferred. Examples of the preferred platinum source are nitrates, chlorides, and ammine complexes of platinum. Concrete examples are chloroplatinic acid, dinitrodiamine platinum, and an aqueous nitric acid solution of dinitrodiaminoplatinum. The source of iron may be iron oxide particles or an iron compound, but a water-soluble salt of iron is preferred. Examples of the preferred iron source are nitrates, chlorides, sulfates, and acetates of iron. Concrete examples are iron nitrate, iron chloride, iron sulfate, and iron acetate.

As an example of preparation of the Pt—Fe composite oxide, an aqueous solution of the above-mentioned platinum compound, e.g., dinitrodiamine platinum, and an aqueous solution of the above iron compound, e.g., iron nitrate, are mixed, the mixture is dried at 110° C., and then calcined at 500° C. to obtain a Pt—Fe composite oxide. The resulting Pt—Fe composite oxide, the target substance, is pulverized and adjusted to an average particle diameter of 0.05 to 10 μm by a sifting means, and can be used as a component of the present catalyst composition.

The proportion of the component 3 which can be incorporated in the catalyst composition is 0.01 to 4.5% by weight, preferably 0.05 to 3.6% by weight, more preferably 0.1 to 2.3% by weight, based on the weight of the catalyst composition.

It goes without saying that the proportions of the catalyst components 1, 2 and 3 incorporated in the catalyst composition are selected, as appropriate, so that they total 100% by weight.

The catalyst composition of the present invention contains the component 1, the component 2 and the component 3 as the essential components. In detail, the catalyst composition of the present invention contains, as the essential components, the component 1 which is at least one member selected from the group consisting of alumina, zirconia, titania, silica, ceria, and ceria-zirconia, each having a noble metal supported thereon; the component 2 which is β zeolite having supported thereon at least one metal selected from the group consisting of Fe, Cu, Co and Ni; and the component 3 which is the Pt—Fe composite oxide. This constitution improves the durability to catalyst poisoning and the silicon resistance probably because of the synergistic effect of the component 1, the component 2 and the component 3. In particular, the catalyst composition of the present invention, which contains the component 1 having Pt supported thereon, for example, Pt-alumina, Pt-ceria/zirconia, Pt-zirconia, Pt-ceria and/or Pt-titania, the component 2 having Fe or Cu supported thereon, for example, Fe-β zeolite or Cu-β zeolite, and the Pt—Fe composite oxide as the component 3, shows dramatic improvements in durability to catalyst poisoning and silicon resistance which are attributed to the synergistic effect of Pt and Fe.

When the Pt-supported component 1, the component 2 being β zeolite having supported thereon at least one metal selected from the group consisting of Fe, Cu, Co and Ni, and the Pt—Fe composite oxide as the component 3 are used for the catalyst composition of the present invention, the catalyst composition is preferably characterized by the features indicated below.

The ratio of the atomic number of the Pt not forming the Pt—Fe composite oxide to the total atomic number of the Pt not forming the Pt—Fe composite oxide and the Pt of the Pt—Fe composite oxide, namely, [Pt not forming Pt—Fe composite oxide]/([Pt not forming Pt—Fe composite oxide]+[Pt of Pt—Fe composite oxide]), is preferably 0.50 to 0.95. It is more preferred for this ratio to be 0.6 to 0.9. By setting the ratio of the atomic number of the Pt not forming the Pt—Fe composite oxide to the total atomic number of the Pt not forming the Pt—Fe composite oxide and the Pt of the Pt—Fe composite oxide at a value in the range of 0.50 to 0.95, more preferably 0.6 to 0.9, the durability of the catalyst against catalyst poisoning and the silicon resistance of the catalyst can be improved. Values lower than or higher than this range would lower the silicon resistance. The element ratio can be found by measuring the XAFS.

The ratio of the atomic number can be adjusted, for example, by setting the Pt—Fe composite oxide in the desired proportions.

The total amount of the noble metals in the catalyst composition of the present invention is not limited, but is preferably in the range of 0.1 to 10.0% by weight, more preferably in the range of 0.5 to 5.0% by weight, most preferably 1.0 to 3.0% by weight.

Catalyst Layer and Support for Catalyst

The catalyst composition of the present invention can further have a binder added thereto. If the binder is added, the binder is preferred in forming a catalyst layer on a support such as a honeycomb in the method for catalyst production to be described later. There are no limitations on the binder, and publicly known binders can be used. Examples of the binder are colloidal silica, alumina sol, silica sol, boehmite, and zirconia sol.

The amount of the binder which can be incorporated in the catalyst composition can be determined, as appropriate, by the amount that can attain the purpose of use of the binder. Normally, it is 1 to 50 parts by weight, preferably 10 to 30 parts by weight, more preferably 15 to 25 parts by weight, for 100 parts by weight of the catalyst composition.

The present invention also relates to a catalyst having a catalyst layer formed on the surface of a catalyst support, the catalyst layer containing the above-described catalyst composition. The catalyst layer containing the above catalyst composition is formed on the surface of a catalyst support, such as cordierite or corrugated honeycomb, by a general manufacturing method, namely, slurry coating or impregnation, whereby a catalyst can be obtained. The shape of the support used is not limited, but is preferably a shape in which a differential pressure produced during gas passage is low and the area of contact with the gas is large. Examples include shapes such as a honeycomb, a sheet, a mesh, fibers, particles, pellets, beads, a ring, a pipe, a net and a filter. The materials for these supports are not limited, and include cordierite, alumina, silica alumina, zirconia, titania, aluminum titanate, SiC, SiN, carbon fibers, metal fibers, glass fibers, ceramic fibers, stainless steel, and a metal such as an Fe—Cr—Al alloy. The preferred material for the support is one excellent in corrosion resistance and heat resistance. The through-hole shape (cell shape) of the honeycomb carrier may be any shape such as a circular, polygonal or corrugated shape. The cell density of the honeycomb carrier is not limited, but is preferably a cell density in the range of 0.9 to 233 cells/cm² (6 to 1500 cells/square inch).

The average thickness of the catalyst layer is 10 μm or more, preferably 20 μm or more, but 500 μm or less, preferably 300 μm or less. If the thickness of the catalyst layer is less than 10 μm, the removal rate of organic compounds may be insufficient. If this thickness exceeds 500 μm, on the other hand, the exhaust gas fails to diffuse sufficiently into the catalyst layer, and is apt to generate in the catalyst layer a part which does not contribute to exhaust gas purification. To obtain the catalyst layer of a predetermined thickness, it is permissible to repeat coating and drying. Herein, the thickness of the catalyst layer is expressed by the following equation:

Thickness of catalyst [μm]=W[g/L]/(TD[g/cm³]×S[cm²/L])×10⁴ Equation 1:

(where W is the amount of the catalyst coating per liter of the support (g/L), TD is the bulk density of the catalyst layer (g/cm³), and S is the surface area per liter of the support (cm²/L)).

The formation of the catalyst layer is performed, for example, by the following methods:

<Method 1> A water slurry containing noble metal-supported particles as the component 1, particles as the component 2, particles as the component 3, and a binder is prepared. This slurry is coated on the above-mentioned support and dried. The method of coating is not limited, and a publicly known method including washcoating or dipping can be employed. After coating, the support is heat-treated at a temperature in the range of 15 to 800° C. The heat treatment may be performed in a reducing atmosphere such as a hydrogen gas. The metal M-supported β zeolite as the component 2 may be one further supporting a noble metal component identical with or different from that of the component 1.
<Method 2> A water slurry containing particles as the component 1 not supporting a noble metal, particles as the component 2, particles as the component 3, and a binder is coated on the support and dried in the same manner as in the above Method 1. The so treated support is impregnated with a solution containing a noble metal component, followed by drying and reduction. Alternatively, after the Method 1 is performed, a noble metal may be added further by Method 2.

With the present invention, an exhaust gas containing organic compounds and organosilicon compounds at an Si concentration of 0.1 ppm to 1000 ppm is brought into contact with the catalyst of the present invention at a temperature of 150 to 500° C. for a reaction, whereby the exhaust gas can be purified. No upper limit is set on the Si concentration of the exhaust gas to be passed through the catalyst composition or the catalyst of the present invention. However, the Si concentration is 1,000 ppm or less, preferably 100 ppm or less, more preferably 20 ppm or less. If the Si concentration exceeds this range, the catalytic activity tends to lower. There is no lower limit to the Si concentration, but the effects of the present invention can be detected at an Si concentration of 0.01 ppm or higher, preferably 0.1 ppm or higher, more preferably 1 ppm or higher.

The method of purifying the exhaust gas by use of the catalyst of the present invention is preferred for purifying an exhaust gas or a furnace gas containing organic compounds (VOC or volatile organic compounds) or organosilicon compounds, the exhaust gas from plants for printing, painting, coating, surface treatment of coating films, electronic materials, plastics, glass, ceramics, etc., and silicone manufacturing, and the furnace gas from PET drawing devices. Furthermore, the catalyst of the present invention is suitable for the purification of exhaust gases containing organophosphorus, organometallic or sulfur compounds.

Organosilicon Compounds and Silicone

The purification of the exhaust gas refers to lowering the concentration of at least one of organic compounds and/or silicon-containing organic compounds (may also be called organosilicon compounds) which are contained in the exhaust gas. The organosilicon compounds herein mean organosilicon compounds having at least one Si—C bond in the molecule. Examples of the organosilicon compound are silanes represented by the formula RₙSiX₄₋ₙ (where R is a hydrogen atom, or an organic group such as an alkyl group having 1 to 10 carbon atoms, an alkoxy group, or a phenyl group, X is independently selected from F, Cl, Br, I, OH, H and amine, and n is an integer of 1 to 3), and other silicon compounds such as siloxanes, silyl group-containing compounds, silanol group-containing compounds, and silicones. Here, the silicones refer to oligomers and polymers having a main chain formed by silicon (Si) and oxygen (O) bound to an organic group, and thermal decomposition products thereof. Their examples include dimethyl silicone, methyl phenyl silicone, cyclic silicone, fatty acid-modified silicone, and polyether-modified silicone compounds. At least one of these organosilicon compounds is contained, in a gaseous, fumy or misty form, in an exhaust gas together with the organic compound, and treated with the catalyst composition of the present invention. Hereinafter, the concentration of the organosilicon compound contained in the exhaust gas may be expressed as an Si concentration. The exhaust gas contains not only the organic compound and/or the organosilicon compound, but also a silicon compound free of an organic group, such as a silicon halide (general formula XₘSiₙ: m is an integer of 1 to 2, and n is an integer of 1 to 12).

The catalyst of the present invention can be used in a method for preventing contamination of a PET drawing furnace, by a method comprising bringing hot air containing a volatile PET oligomer, which is generated during production of a PET film in the drawing furnace, into contact with the catalyst of the present invention provided within or outside the drawing furnace, at a temperature in the range of 200 to 350° C., to decompose the volatile PET oligomer oxidatively (Step 1); and, after Step 1, refluxing all or part of the resulting decomposition gas into the drawing furnace (Step 2).

The present invention will now be illustrated by Examples.

### EXAMPLES

In the Examples, the following inorganic oxides, zeolites, binders and support were used:

Inorganic Oxides

Zirconia [(produced by DAIICHI KIGENSO KAGAKU KOGYO CO., LTD., average particle diameter 5 μm, BET specific surface area 100 m²/g)]

Ceria [(produced by DAIICHI KIGENSO KAGAKU KOGYO CO., LTD., average particle diameter 0.5 μm, BET specific surface area 120 m²/g)]

Ceria-zirconia [(produced by DAIICHI KIGENSO KAGAKU KOGYO CO., LTD., average particle diameter 5 μm, BET specific surface area 120 m²/g)]

Titania [TiO₂ powder (produced by Millennium Pharmaceuticals, Inc., average particle diameter 1 μm, BET specific surface area 300 m²/g)]

Alumina [γ-alumina powder (produced by Nikki-Universal Co., Ltd., average particle diameter 5 μm)]

Zeolites

Fe-β zeolite [(produced by Clariant Catalysts (Japan) K.K., average particle diameter 91 μm, SiO₂/Al₂O₃ molar ratio 25, 5% by weight-Fe₂O₃)]

Cu-β zeolite [(produced by Clariant Catalysts (Japan) K.K., average particle diameter 85 μm, SiO₂/Al₂O₃ molar ratio 35, 5% by weight-CuO)]

HY [Y type zeolite powder (produced by UOP K.K., commercial name LZY84, average particle diameter 2 μm, SiO₂/Al₂O₃ molar ratio 5.9, H type substitution product) 50 g]

Binder

Boehmite (produced by UOP K.K., Versal-250)

Alumina sol (produced by NISSAN CHEMICAL INDUSTRIES, LTD., ALUMINASOL-520, 20% by weight as Al₂O₃ solids)

Silica sol (produced by NISSAN CHEMICAL INDUSTRIES, LTD., SNOWTEX-C, 20% by weight as SiO₂ solids)

Support

Cordierite honeycomb (produced by NGK INSULATORS, LTD., 200 cells/square inch)

Preparation of Pt—Fe Composite Oxide

Pt—Fe composite oxide 1: An aqueous solution of dinitrodiamine platinum (produced by Tanaka Kikinzoku Kogyo) and iron(III) nitrate nonahydrate (Wako Pure Chemical Industries, Ltd.) were dissolved in deionized water such that the atomic ratio Fe/(Pt+Fe) was 0.25. The resulting Fe—Pt mixed solution was dried at 110° C., and then calcined at 500° C., whereby a Pt—Fe composite oxide having an Fe/(Pt+Fe) atomic ratio of 0.25 was obtained. It was confirmed that 95% or more of the platinum and iron charged changed into the Pt—Fe composite oxide.

Pt—Fe composite oxide 2: Preparation was performed in the same manner as for the Pt—Fe composite oxide 1, except that the atomic ratio Fe/(Pt+Fe) was 0.3. As a result, a Pt—Fe composite oxide having an Fe/(Pt+Fe) atomic ratio of 0.29 was obtained. It was confirmed that 95% or more of the platinum and iron charged changed into the Pt—Fe composite oxide.

Pt—Fe composite oxide 3: Preparation was performed in the same manner as for the Pt—Fe composite oxide 1, except that the atomic ratio Fe/(Pt+Fe) was 0.35. As a result, a Pt—Fe composite oxide having an Fe/(Pt+Fe) atomic ratio of 0.35 was obtained. It was confirmed that 95% or more of the platinum and iron charged changed into the Pt—Fe composite oxide.

Pt—Fe composite oxide 4: Preparation was performed in the same manner as for the Pt—Fe composite oxide 1, except that the atomic ratio Fe/(Pt+Fe) was 0.17. As a result, a Pt—Fe composite oxide having an Fe/(Pt+Fe) atomic ratio of 0.17 was obtained. It was confirmed that 95% or more of the platinum and iron charged changed into the Pt—Fe composite oxide.

Pt—Fe composite oxide 5: Preparation was performed in the same manner as for the Pt—Fe composite oxide 1, except that the atomic ratio Fe/(Pt+Fe) was 0.20. As a result, a Pt—Fe composite oxide having an Fe/(Pt+Fe) atomic ratio of 0.20 was obtained. It was confirmed that 95% or more of the platinum and iron charged changed into the Pt—Fe composite oxide.

Pt—Fe composite oxide 6: Preparation was performed in the same manner as for the Pt—Fe composite oxide 1, except that the atomic ratio Fe/(Pt+Fe) was 0.19. As a result, a Pt—Fe composite oxide having an Fe/(Pt+Fe) atomic ratio of 0.19 was obtained. It was confirmed that 95% or more of the platinum and iron charged changed into the Pt—Fe composite oxide.

Pt—Fe composite oxide 7: Preparation was performed in the same manner as for the Pt—Fe composite oxide 1, except that the atomic ratio Fe/(Pt+Fe) was 0.15. As a result, a Pt—Fe composite oxide having an Fe/(Pt+Fe) atomic ratio of 0.15 was obtained. It was confirmed that 95% or more of the platinum and iron charged changed into the Pt—Fe composite oxide.

Preparation of Catalyst

Preparation of Pt/Al₂O₃+FeP+Pt—Fe Composite Oxide-Containing Catalysts Having Fe/(Pt+Fe) Atomic Ratio of Pt—Fe Composite Oxide Changed

Catalyst 1:

The Pt—Fe composite oxide 1 (Fe/(Pt+Fe) atomic ratio=0.25) in an amount of 1.08 g as Pt, 120 g of γ-alumina powder (produced by Nikki-Universal Co., Ltd., average particle diameter 5 μm) as solids, 120 g of Fe-β zeolite (produced by Clariant Catalysts (Japan) K.K., SiO₂/Al₂O₃ molar ratio 25, 5% by weight-Fe₂O₃, average particle diameter 91 μm) as solids, and 60 g of an alumina sol binder as solids were mixed with 451 g of deionized water to prepare a slurry. This slurry was coated on a cordierite honeycomb (produced by NGK INSULATORS, LTD., 200 cells/square inch) by washcoating so that the weight of the resulting catalyst layer per liter of the honeycomb would be 80 g (except the binder). After the excess slurry was blown off by compressed air, the coated support was dried for 3 hours at 150° C. in a dryer. Then, the dried support was calcined for 1 hour at 500° C. in air, whereafter the calcined support was impregnated with an aqueous solution of dinitrodiamine platinum (produced by Tanaka Kikinzoku Kogyo) so that the total Pt content would be 1.8 g/L (per liter of the catalyst support). The impregnated material was dried for 3 hours at 150° C., and then reduced for 1 hour in a hydrogen atmosphere at 500° C. to obtain catalyst 1 as Pt/Al₂O₃+Feβ in which the Fe/(Pt+Fe) atomic ratio of the Pt—Fe composite oxide was 0.25.

Hereinafter, g/L indicated as a unit of the Pt content represents the Pt content (g) of the catalyst per liter of the catalyst support, unless otherwise described.

Catalyst 2:

Preparation was performed in the same manner as for the catalyst 1, except that the Pt—Fe composite oxide 2 (Fe/(Pt+Fe) atomic ratio=0.29) was used. Catalyst 2 as Pt/Al₂O₃+Feβ was obtained in which the Fe/(Pt+Fe) atomic ratio of the Pt—Fe composite oxide was 0.29.

Catalyst 3:

Preparation was performed in the same manner as for the catalyst 1, except that the Pt—Fe composite oxide 3 (Fe/(Pt+Fe) atomic ratio=0.35) was used. Catalyst 3 as Pt/Al₂O₃+Feβ was obtained in which the Fe/(Pt+Fe) atomic ratio of the Pt—Fe composite oxide was 0.35.

Catalyst 4:

Preparation was performed in the same manner as for the catalyst 1, except that the Pt—Fe composite oxide 4 (Fe/(Pt+Fe) atomic ratio=0.17) was used. Catalyst 4 as Pt/Al₂O₃+Feβ was obtained in which the Fe/(Pt+Fe) atomic ratio of the Pt—Fe composite oxide was 0.17.

Catalyst 5:

Preparation was performed in the same manner as for the catalyst 1, except that the Pt—Fe composite oxide 5 (Fe/(Pt+Fe) atomic ratio=0.20) was used. Catalyst 5 as Pt/Al₂O₃+Feβ was obtained in which the Fe/(Pt+Fe) atomic ratio of the Pt—Fe composite oxide was 0.20.

Catalyst 6:

Preparation was performed in the same manner as for the catalyst 1, except that the Pt—Fe composite oxide 6 (Fe/(Pt+Fe) atomic ratio=0.19) was used. Catalyst 6 as Pt/Al₂O₃+Feβ was obtained in which the Fe/(Pt+Fe) atomic ratio of the Pt—Fe composite oxide was 0.19.

Catalyst 7:

Preparation was performed in the same manner as for the catalyst 1, except that the Pt—Fe composite oxide 7 (Fe/(Pt+Fe) atomic ratio=0.15) was used. Catalyst 7 as Pt/Al₂O₃+Feβ was obtained in which the Fe/(Pt+Fe) atomic ratio of the Pt—Fe composite oxide was 0.15.

Table 1 below shows the results of the analysis, based on XAFS, of the Fe/(Pt+Fe) ratio of the Pt—Fe composite oxide in each of the catalysts prepared. Table 1 also shows the results of the XAFS analysis of the ratio of the atomic number of the Pt not forming the Pt—Fe composite oxide to the total atomic number of the Pt not forming the Pt—Fe composite oxide and the Pt of the Pt—Fe composite oxide. Table 1 further shows the results of the analysis of the Pt average particle diameter by the CO adsorption method.

TABLE 1

| | | | Ratio⁽¹⁾ of atomic number | | |
|---|---|---|---|---|---|
| | | | of Pt not forming Pt—Fe | | |
| | | | composite oxide to total | Pt content | |
| | | Fe/(Pt + Fe) | atomic number of Pt not | (g/liter of | Pt average |
| | | atomic ratio | forming Pt—Fe composite | catalyst | particle |
| | Catalyst | of Pt—Fe | oxide and Pt of Pt—Fe | support) in | diameter |
| | composition | composite oxide | composite oxide | catalyst | (nm) |
| Catalyst 1 | Pt/Al₂O₃ + Feβ + | 0.25 | 0.8 | 1.8 | 6.0 |
| | Pt—Fe | | | | |
| | composite oxide | | | | |
| Catalyst 2 | Pt/Al₂O₃ + Feβ + | 0.29 | 0.8 | 1.8 | 5.7 |
| | Pt—Fe | | | | |
| | composite oxide | | | | |
| Catalyst 3 | Pt/Al₂O₃ + Feβ + | 0.35 | 0.8 | 1.8 | 5.9 |
| | Pt—Fe | | | | |
| | composite oxide | | | | |
| Catalyst 4 | Pt/Al₂O₃ + Feβ + | 0.17 | 0.8 | 1.8 | 6.2 |
| | Pt—Fe | | | | |
| | composite oxide | | | | |
| Catalyst 5 | Pt/Al₂O₃ + Feβ + | 0.20 | 0.8 | 1.8 | 6.1 |
| | Pt—Fe | | | | |
| | composite oxide | | | | |
| Catalyst 6 | Pt/Al₂O₃ + Feβ + | 0.19 | 0.8 | 1.8 | 5.7 |
| | Pt—Fe | | | | |
| | composite oxide | | | | |
| Catalyst 7 | Pt/Al₂O₃ + Feβ + | 0.15 | 0.8 | 1.8 | 5.8 |
| | Pt—Fe | | | | |
| | composite oxide | | | | |

Notes:
⁽¹⁾represents [Pt not forming Pt—Fe composite oxide]/([Pt not forming Pt—Fe composite oxide] + [Pt of Pt—Fe composite oxide])

Preparation of Catalysts Changed in Ratio of Atomic Number of Pt not Forming Pt—Fe Composite Oxide to Total Atomic Number of Pt not Forming Pt—Fe Composite Oxide and Pt of Pt—Fe Composite Oxide

Catalyst 8:

The Pt—Fe composite oxide 1 (Fe/(Pt+Fe) atomic ratio=0.25) in an amount of 2.7 g as Pt, 120 g of γ-alumina powder (produced by Nikki-Universal Co., Ltd., average particle diameter 5 μm) as solids, 120 g of Fe-β zeolite (produced by Clariant Catalysts (Japan) K.K., SiO₂/Al₂O₃ molar ratio 25, 5% by weight-Fe₂O₃, average particle diameter 91 μm) as solids, and 60 g of an alumina sol binder as solids were mixed with 451 g of deionized water to prepare a slurry. This slurry was coated on a cordierite honeycomb (produced by NGK INSULATORS, LTD., 200 cells/square inch) by washcoating so that the weight of the resulting catalyst layer per liter of the honeycomb would be 80 g (except the binder). After the excess slurry was blown off by compressed air, the coated support was dried for 3 hours at 150° C. in a dryer. Then, the dried support was calcined for 1 hour at 500° C. in air, whereafter the calcined support was impregnated with an aqueous solution of dinitrodiamine platinum (produced by Tanaka Kikinzoku Kogyo) so that the total Pt content would be 1.8 g/L. The impregnated material was dried for 3 hours at 150° C., and then reduced for 1 hour in a hydrogen atmosphere at 500° C. to obtain catalyst 8 as Pt/Al₂O₃+Feβ in which the ratio of the atomic number of the Pt not forming the Pt—Fe composite oxide to the total atomic number of the Pt not forming the Pt—Fe composite oxide and the Pt of the Pt—Fe composite oxide, i.e., [Pt not forming Pt—Fe composite oxide/(Pt not forming composite oxide+Pt of Pt—Fe composite oxide)], was 0.5.

Catalyst 9:

Preparation was performed in the same manner as for the catalyst 8, except that the amount of the Pt—Fe composite oxide 1 (Fe/(Pt+Fe) atomic ratio=0.25) was changed to 2.16 g as Pt. Catalyst 9 as Pt/Al₂O₃+Feβ was obtained in which the ratio of the atomic number of the Pt not forming the Pt—Fe composite oxide to the total atomic number of the Pt not forming the Pt—Fe composite oxide and the Pt of the Pt—Fe composite oxide, i.e., [Pt not forming Pt—Fe composite oxide/(Pt not forming composite oxide+Pt of Pt—Fe composite oxide)], was 0.6.

Catalyst 10:

Preparation was performed in the same manner as for the catalyst 8, except that the amount of the Pt—Fe composite oxide 1 (Fe/(Pt+Fe) atomic ratio=0.25) was changed to 0.27 g as Pt. Catalyst 10 as Pt/Al₂O₃+Feβ was obtained in which the ratio of the atomic number of the Pt not forming the Pt—Fe composite oxide to the total atomic number of the Pt not forming the Pt—Fe composite oxide and the Pt of the Pt—Fe composite oxide, i.e., [Pt not forming Pt—Fe composite oxide/(Pt not forming composite oxide+Pt of Pt—Fe composite oxide)], was 0.95.

Catalyst 11:

Preparation was performed in the same manner as for the catalyst 8, except that the amount of the Pt—Fe composite oxide 1 (Fe/(Fe+Pt) atomic ratio=0.25) was changed to 2.16 g as Pt. Catalyst 11 as Pt/Al₂O₃+Feβ was obtained in which the ratio of the atomic number of the Pt not forming the Pt—Fe composite oxide to the total atomic number of the Pt not forming the Pt—Fe composite oxide and the Pt of the Pt—Fe composite oxide, i.e., [Pt not forming Pt—Fe composite oxide/(Pt not forming composite oxide+Pt of Pt—Fe composite oxide)], was 0.45.

Catalyst 12:

Preparation was performed in the same manner as for the catalyst 8, except that the amount of the Pt—Fe composite oxide 1 (Fe/(Fe+Pt) atomic ratio=0.25) was changed to 0.27 g as Pt. Catalyst 12 as Pt/Al₂O₃+Feβ was obtained in which the ratio of the atomic number of the Pt not forming the Pt—Fe composite oxide to the total atomic number of the Pt not forming the Pt—Fe composite oxide and the Pt of the Pt—Fe composite oxide, i.e., [Pt not forming Pt—Fe composite oxide/(Pt not forming composite oxide+Pt of Pt—Fe composite oxide)], was 0.35.

Reference catalyst 1:

120 g of γ-alumina powder (produced by Nikki-Universal Co., Ltd., average particle diameter 5 μm) as solids, 120 g of Fe-β zeolite (produced by Clariant Catalysts (Japan) K.K., SiO₂/Al₂O₃ molar ratio 25, 5% by weight-Fe₂O₃, average particle diameter 91 μm) as solids, and 60 g of an alumina sol binder as solids were mixed with 451 g of deionized water to prepare a slurry. This slurry was coated on a cordierite honeycomb (produced by NGK INSULATORS, LTD., 200 cells/square inch) by washcoating so that the weight of the resulting catalyst layer per liter of the honeycomb would be 80 g (except the binder). After the excess slurry was blown off by compressed air, the coated support was dried for 3 hours at 150° C. in a dryer. Then, the dried support was calcined for 1 hour at 500° C. in air, whereafter the calcined support was impregnated with an aqueous solution of dinitrodiamine platinum (produced by Tanaka Kikinzoku Kogyo) so that the total Pt content would be 1.8 g/L (per liter of the catalyst support). The impregnated material was dried for 3 hours at 150° C., and then reduced for 1 hour in a hydrogen atmosphere at 500° C. to obtain reference catalyst 1 free of a Pt—Fe composite oxide.

Table 2 shows the results of the analysis, based on XAFS, of the Fe/(Pt+Fe) atomic ratio of the Pt—Fe composite oxide in each of the catalysts prepared as above. Table 2 also shows the results of the XAFS analysis of the ratio of the atomic number of the Pt not forming the Pt—Fe composite oxide to the total atomic number of the Pt not forming the Pt—Fe composite oxide and the Pt of the Pt—Fe composite oxide. Table 2 further shows the results of the analysis of the Pt average particle diameter by the CO adsorption method.

TABLE 2

| | | | Ratio⁽¹⁾ of atomic number | | |
|---|---|---|---|---|---|
| | | | of Pt not forming Pt—Fe | | |
| | | | composite oxide to total | Pt content | |
| | | Fe/(Pt + Fe) | atomic number of Pt not | (g/liter of | Pt average |
| | | atomic ratio | forming Pt—Fe composite | catalyst | particle |
| | Catalyst | of Pt—Fe | oxide and Pt of Pt—Fe | support) in | diameter |
| | composition | composite oxide | composite oxide | catalyst | (nm) |
| Catalyst 1 | Pt/Al₂O₃ + Feβ + | 0.25 | 0.8 | 1.8 | 6.0 |
| | Pt—Fe | | | | |
| | composite oxide | | | | |
| Catalyst 8 | Pt/Al₂O₃ + Feβ + | 0.25 | 0.5 | 1.8 | 5.6 |
| | Pt—Fe | | | | |
| | composite oxide | | | | |
| Catalyst 9 | Pt/Al₂O₃ + Feβ + | 0.25 | 0.6 | 1.8 | 5.8 |
| | Pt—Fe | | | | |
| | composite oxide | | | | |
| Catalyst 10 | Pt/Al₂O₃ + Feβ + | 0.25 | 0.95 | 1.8 | 6.3 |
| | Pt—Fe | | | | |
| | composite oxide | | | | |
| Catalyst 11 | Pt/Al₂O₃ + Feβ + | 0.25 | 0.45 | 1.8 | 6.0 |
| | Pt—Fe | | | | |
| | composite oxide | | | | |
| Catalyst 12 | Pt/Al₂O₃ + Feβ + | 0.25 | 0.35 | 1.8 | 5.9 |
| | Pt—Fe | | | | |
| | composite oxide | | | | |
| Reference | Pt/Al₂O₃ + Feβ | — | 1 | 1.8 | 6.4 |
| Catalyst 1 | | | | | |

Notes:
⁽¹⁾represents [Pt not forming Pt—Fe composite oxide]/([Pt not forming Pt—Fe composite oxide] + [Pt of Pt—Fe composite oxide])

Preparation of Catalysts with Pt Average Particle Diameter Changed

To investigate the influence of the Pt average particle diameter on resistance to silicon poisoning, catalysts having a Pt average particle diameter changed were prepared. The Pt average particle diameter can be changed by changing the calcining temperature of a Pt-supported catalyst such as Pt-supported Al₂O₃ or Pt-supported ZrO₂.

Catalyst 13:

γ-alumina powder (produced by Nikki-Universal Co., Ltd., average particle diameter 5 μm) was impregnated with an aqueous solution of dinitrodiamine platinum (produced by Tanaka Kikinzoku Kogyo) so as to have a Pt content of 3.6% by weight. The impregnated powder was dried for 3 hours at 150° C., then reduced for 1 hour in a hydrogen atmosphere at 500° C., and then calcined in air for 4 hours at 500° C. to form Pt/Al₂O₃ particles. (As stated above, the Pt average particle diameter can be varied by changing the calcining temperature. In order that other catalyst components would not be affected by calcining, however, the particles were calcined in the state of Pt/Al₂O₃.) The Pt/Al₂O₃ particles (120 g), 1.08 g of the Pt—Fe composite oxide 1 (Fe/(Pt+Fe) atomic ratio=0.25), 120 g of Fe-β zeolite (produced by Clariant Catalysts (Japan) K.K., SiO₂/Al₂O₃ molar ratio 25, 5% by weight-Fe₂O₃, average particle diameter 91 μm), and 60 g of an alumina sol binder as solids were mixed with 451 g of deionized water to prepare a slurry. This slurry was coated on a cordierite honeycomb (produced by NGK INSULATORS, LTD., 200 cells/square inch) by washcoating so that the weight of the resulting catalyst layer per liter of the honeycomb would be 80 g (except the binder). After the excess slurry was blown off by compressed air, the coated support was dried for 3 hours at 150° C. in a dryer. Then, the dried support was reduced for 1 hour in a hydrogen atmosphere at 500° C. to obtain a honeycomb type catalyst 13 having a catalyst layer, Pt/Al₂O₃+Feβ, supported thereon.

Catalyst 14:

Prepared in the same manner as for the catalyst 13, except that the calcining temperature of the Pt/Al₂O₃ particles for the catalyst 13 was changed to 550° C.

Catalyst 15:

Prepared in the same manner as for the catalyst 13, except that the calcining temperature of the Pt/Al₂O₃ particles for the catalyst 13 was changed to 600° C.

Catalyst 16:

Prepared in the same manner as for the catalyst 13, except that the calcining temperature of the Pt/Al₂O₃ particles for the catalyst 13 was changed to 700° C.

Catalyst 17:

Prepared in the same manner as for the catalyst 13, except that the calcining temperature of the Pt/Al₂O₃ particles for the catalyst 13 was changed to 750° C.

Catalyst 18:

Prepared in the same manner as for the catalyst 13, except that the Pt/Al₂O₃ particles for the catalyst 13 were reduced, and then added without being calcined.

Catalyst 19:

Prepared in the same manner as for the catalyst 13, except that the calcining temperature of the Pt/Al₂O₃ particles for the catalyst 13 was changed to 725° C.

Table 3 shows the results of the analysis, based on XAFS, of the Fe/(Pt+Fe) ratio of the Pt—Fe composite oxide in each of the catalysts prepared as above. Table 3 also shows the results of the XAFS analysis of the ratio of the atomic number of the Pt not forming the Pt—Fe composite oxide to the total atomic number of the Pt not forming the Pt—Fe composite oxide and the Pt of the Pt—Fe composite oxide. Table 3 further shows the results of the analysis of the Pt average particle diameter by the CO adsorption method.

TABLE 3

| | | | Ratio⁽¹⁾ of atomic number | | |
|---|---|---|---|---|---|
| | | | of Pt not forming Pt—Fe | | |
| | | | composite oxide to total | Pt content | |
| | | Fe/(Pt + Fe) | atomic number of Pt not | (g/liter of | Pt average |
| | | atomic ratio | forming Pt—Fe composite | catalyst | particle |
| | Catalyst | of Pt—Fe | oxide and Pt of Pt—Fe | support) in | diameter |
| | composition | composite oxide | composite oxide | catalyst | (nm) |
| Catalyst 1 | Pt/Al₂O₃ + Feβ + | 0.25 | 0.8 | 1.8 | 6.0 |
| | Pt—Fe | | | | |
| | composite oxide | | | | |
| Catalyst 13 | Pt/Al₂O₃ + Feβ + | 0.25 | 0.8 | 1.8 | 1.1 |
| | Pt—Fe | | | | |
| | composite oxide | | | | |
| Catalyst 14 | Pt/Al₂O₃ + Feβ + | 0.25 | 0.8 | 1.8 | 2.3 |
| | Pt—Fe | | | | |
| | composite oxide | | | | |
| Catalyst 15 | Pt/Al₂O₃ + Feβ + | 0.25 | 0.8 | 1.8 | 12.3 |
| | Pt—Fe | | | | |
| | composite oxide | | | | |
| Catalyst 16 | Pt/Al₂O₃ + Feβ + | 0.25 | 0.8 | 1.8 | 20.5 |
| | Pt—Fe | | | | |
| | composite oxide | | | | |
| Catalyst 17 | Pt/Al₂O₃ + Feβ + | 0.25 | 0.8 | 1.8 | 31.2 |
| | Pt—Fe | | | | |
| | composite oxide | | | | |
| Catalyst 18 | Pt/Al₂O₃+Feβ + | 0.25 | 0.8 | 1.8 | 0.8 |
| | Pt—Fe | | | | |
| | composite oxide | | | | |
| Catalyst 19 | Pt/Al₂O₃ + Feβ + | 0.25 | 0.8 | 1.8 | 27.0 |
| | Pt—Fe | | | | |
| | composite oxide | | | | |

Notes:
⁽¹⁾represents [Pt not forming Pt—Fe composite oxide]/([Pt not forming Pt—Fe composite oxide] + [Pt of Pt—Fe composite oxide])

Working examples of catalysts having components changed:

Catalysts having the inorganic oxide component as the component 1 changed were prepared in order to investigate whether silicon resistance could be obtained in spite of a change in the type of the noble metal-supported inorganic oxide. Catalysts having the metal component in the component 2 changed were also prepared in order to investigate whether silicon resistance could be obtained despite a change in the type of the metal supported on β zeolite in the component 2.

Catalyst 20: Preparation of Pt/ZrO₂+Feβ+Pt—Fe composite oxide

Catalyst 20 was prepared in the same manner as for the catalyst 1, except that 120 g of ZrO₂ (produced by DAIICHI KIGENSO KAGAKU KOGYO CO., LTD., average particle diameter 5 μm, BET specific surface area 100 m²/g) was used as solids instead of the γ-Al₂O₃ powder for the catalyst 1.

Catalyst 21: Preparation of Pt/ZrO₂+Feβ+Pt—Fe composite oxide with Pt content changed

Catalyst 21 was prepared in the same manner as for the catalyst 20, except that the amount of the Pt—Fe composite oxide used for the catalyst 20 was changed to 0.48 g, and impregnation with the aqueous solution of dinitrodiamine platinum was performed so that the total Pt content (Pt content of the catalyst per liter of the catalyst support) would be 0.8 g/L.

Catalyst 22: Preparation of Pt/ZrO₂+Cuβ+Pt—Fe composite oxide

Catalyst 22 was prepared in the same manner as for the catalyst 20, except that Cuβ (produced by Clariant Catalysts (Japan) K.K., average particle diameter 260 μm, SiO₂/Al₂O₃ molar ratio 35, 5% by weight-CuO) was used instead of the Feβ for the catalyst 21.

Catalyst 23: Preparation of Pt/CeO₂.ZrO₂+Feβ+Pt—Fe composite oxide

Catalyst 23 was prepared in the same manner as for the catalyst 1, except that 120 g of CeO₂.ZrO₂ (produced by DAIICHI KIGENSO KAGAKU KOGYO CO., LTD., average particle diameter 5 BET specific surface area 120 m²/g) as solids was used instead of the γ-Al₂O₃ powder for the catalyst 1.

Catalyst 24: Preparation of Pt/CeO₂.ZrO₂+CuP+Pt—Fe composite oxide

Catalyst 24 was prepared in the same manner as for the catalyst 23, except that 120 g of Cuβ (produced by Clariant Catalysts (Japan) K.K., average particle diameter 85 μm, SiO₂/Al₂O₃ molar ratio 35, 5% by weight-CuO) as solids was used instead of the Feβ for the catalyst 23.

Catalyst 25: Preparation of Pt/TiO₂+Feβ+Pt—Fe composite oxide

The Pt—Fe composite oxide 1 (Fe/(Pt+Fe) atomic ratio=0.25) in an amount of 1.08 g as Pt, 120 g of TiO₂ (produced by Millennium Pharmaceuticals, Inc., average particle diameter 1 BET specific surface area 300 m²/g) as solids, 120 g of Fe-β zeolite (produced by Clariant Catalysts (Japan) K.K., SiO₂/Al₂O₃ molar ratio 25, 5% by weight-Fe₂O₃, average particle diameter 91 μm) as solids, and 60 g of an alumina sol binder as solids were mixed with 451 g of deionized water to prepare a slurry. This slurry was coated on a cordierite honeycomb (produced by NGK INSULATORS, LTD., 200 cells/square inch) by washcoating so that the weight of the resulting catalyst layer per liter of the honeycomb would be 80 g (except the binder). After the excess slurry was blown off by compressed air, the coated support was dried for 3 hours at 150° C. in a dryer. Then, the dried support was impregnated with an aqueous solution of dinitrodiamine platinum (produced by Tanaka Kikinzoku Kogyo) so that the total Pt content would be 1.8 g/L. The impregnated material was dried for 3 hours at 150° C., and then reduced for 1 hour in a hydrogen atmosphere at 500° C. to obtain catalyst 25.

Preparation of Comparative Catalysts

### Comparative Example 1

### Preparation of Pt/Al₂O₃+HY

25 g of γ-alumina powder (produced by Nikki-Universal Co., Ltd., average particle diameter 5 μm) as solids, 25 g of HY zeolite (produced by UOP K.K., commercial name LZY84, SiO₂/Al₂O₃ molar ratio 5.9, average particle diameter 2 μm) as solids, and 13 g of an alumina sol binder as solids were mixed with 219 g of deionized water to prepare a slurry. This slurry was coated on a cordierite honeycomb (produced by NGK INSULATORS, LTD., 200 cells/square inch) by washcoating so that the weight of the resulting catalyst layer per liter of the honeycomb would be 56 g (except the binder). After the excess slurry was blown off by compressed air, the coated support was dried for 3 hours at 150° C. in a dryer. Subsequent calcining, impregnation for Pt content, and reduction were performed in the same manner as for the catalyst 1, to prepare a catalyst of comparative example 1.

### Comparative Example 2

### Preparation of Pt/Al₂O₃+HY with Different Pt Content

A catalyst of comparative example 2 was prepared in the same manner as for the catalyst of the comparative example 1, except that the Pt content was set at 0.8 g/L.

### Comparative Example 3

### Preparation of Pt/ZrO₂

ZrO₂ powder (produced by DAIICHI KIGENSO KAGAKU KOGYO CO., LTD., average particle diameter 5 μm, BET specific surface area 100 m²/g) in an amount of 72 g as solids, and 18 g of a silica sol binder as solids were mixed with 135 g of deionized water to prepare a slurry. This slurry was coated by washcoating. Drying and later methods were performed in the same manner as for the catalyst of the comparative example 1 to prepare a catalyst of comparative example 3.

### Comparative Example 4

### Preparation of Pt/Al₂O₃

42 g of γ-alumina powder (produced by Nikki-Universal Co., Ltd., average particle diameter 5 μm) as solids, 21 g of boehmite (produced by UOP K.K., Versal-250) as solids serving as a binder, and 6 g of nitric acid were mixed with 223 g of deionized water to prepare a slurry. This slurry was coated by washcoating. Drying and later methods were performed in the same manner as for the catalyst of the comparative example 1 to prepare a catalyst of comparative example 4.

### Comparative Example 5

### Preparation of Pt/CeO₂.ZrO₂

A catalyst of comparative example 5 was prepared in the same manner as for the catalyst of the comparative example 3, except that ceria-zirconia (produced by DAIICHI KIGENSO KAGAKU KOGYO CO., LTD., average particle diameter 5 μm, BET specific surface area 120 m²/g) was used instead of the ZrO₂ powder in the comparative example 3.

### Comparative Example 6

### Preparation of Pt/TiO₂

Titania powder (produced by Millennium Pharmaceuticals, Inc., average particle diameter 1 μm, BET specific surface area 300 m²/g) in an amount of 72 g as solids, 18 g of a silica sol binder as solids, and 6 g of nitric acid were mixed with 135 g of deionized water to prepare a slurry. This slurry was coated by washcoating. After the excess slurry was blown off by compressed air, the coated support was dried for 3 hours at 150° C. in a dryer. Then, the dried support was reduced for 1 hour in a hydrogen atmosphere at 500° C. to obtain a catalyst of comparative example 6.

### Comparative Example 7

### Preparation of FeP Catalyst

72 g of Feβ (produced by Clariant Catalysts (Japan) K.K., average particle diameter 91 μm, SiO₂/Al₂O₃ molar ratio 25, 5% by weight-Fe₂O₃) as solids, and 18 g of a silica sol binder as solids were mixed with 135 g of deionized water to prepare a slurry. This slurry was coated by washcoating. After the excess slurry was blown off by compressed air, the coated support was dried for 3 hours at 150° C. in a dryer. Then, the dried support was calcined for 1 hour at 500° C. to obtain a catalyst of comparative example 7.

### Comparative Example 8

### Preparation of Cuβ Catalyst

A catalyst of comparative example 8 was prepared in the same manner as for the catalyst of the comparative example 7, except that Cu-β zeolite (produced by Clariant Catalysts (Japan) K.K., average particle diameter 85 μm, SiO₂/Al₂O₃ molar ratio 35, 5% by weight-CuO) was used instead of the Fep powder in the comparative example 7.

Exhaust Gas Treatment Test 1 (Organosilicon Compound Poisoning Test at 230° C.)

Each of the catalysts was charged into a reactor (vertical flow apparatus), and a 24-hour exhaust gas treatment test was conducted. The test was performed by flowing an exhaust gas through the reactor at a gas space velocity (SV) of 50,000 hr⁻¹, while maintaining the catalyst layer at 230° C., and analyzing the composition of the gas exiting from the reactor. Herein, the SV was the flow rate of the exhaust gas divided by the volume of the support. The MEK concentration in the exhaust gas before treatment (C1) was measured by sampling the gas at the inlet of the reactor, while the MEK concentration in the exhaust gas after treatment (C2) was measured by sampling the gas at the outlet of the reactor.

The composition of the exhaust gas flowed through the reactor was as follows:

Methyl ethyl ketone (MEK): 500 ppm

Trimethylsiloxane: 1.25 ppm as Si

Water: 2 vol. %

Air: Remainder

MEK decomposition rate

The MEK decomposition rate was calculated from the following equation:

MEK decomposition rate(%)=100×(C1−C2)/C1

(where C1 is the MEK concentration at the inlet of the reactor, and C2 is the MEK concentration at the outlet of the reactor.)

(Test Results)

### Example 1

### Example of Organosilicon Compound Poisoning Test on Pt/Al₂O₃+Feβ+Pt—Fe Composite Oxide-Containing Catalyst

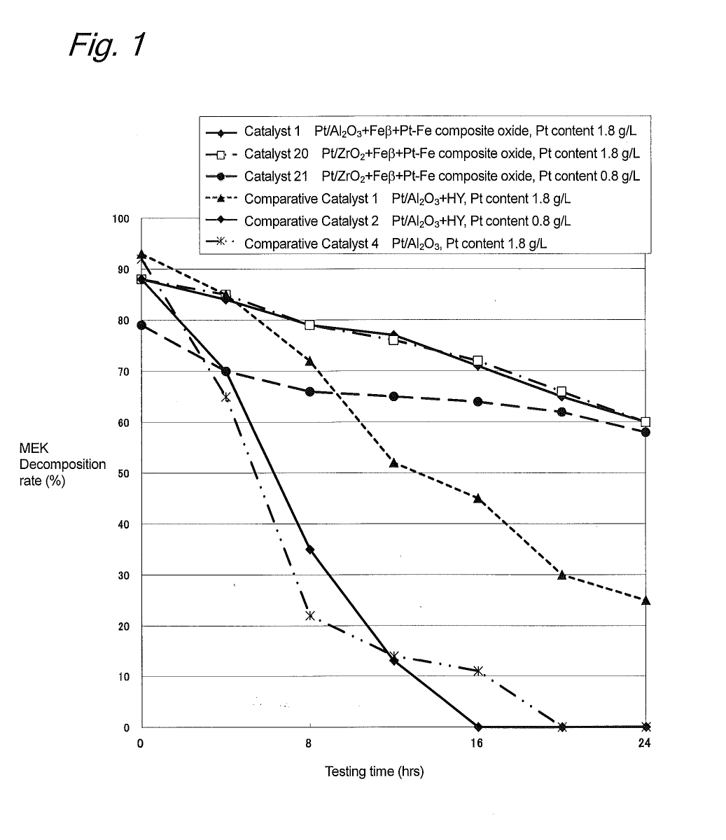

Table 4 and FIG. 1 show the MEK decomposition rates at start of, and 24 hours after, the test in which the exhaust gas containing the organosilicon compound (trimethylsiloxane) was flowed through the catalysts 1 and 20 to 25, the catalysts of the present invention, and the comparative catalysts 1 to 4, 7 and 8, the catalysts of the comparative examples.

TABLE 4

| | | Pt content | MEK | MEK |
|---|---|---|---|---|
| | | in catalyst | decomposition | decomposition |
| Catalyst | Catalyst | (g/liter of | rate (%) | rate (%) |
| name | composition | catalyst support) | At start | After 24 hours |
| Catalyst 1 | Pt/Al₂O₃ + Feβ + | 1.8 | 88 | 60 |
| | Pt—Fe | | | |
| | composite oxide | | | |
| Catalyst 20 | Pt/ZrO₂ + Feβ + | 1.8 | 88 | 60 |
| | Pt—Fe | | | |
| | composite oxide | | | |
| Catalyst 21 | Pt/ZrO₂ + Feβ + | 0.8 | 79 | 58 |
| | Pt—Fe | | | |
| | composite oxide | | | |
| Catalyst 22 | Pt/ZrO₂ + Cuβ + | 1.8 | 88 | 59 |
| | Pt—Fe | | | |
| | composite oxide | | | |
| Catalyst 23 | Pt/CeO₂•ZrO₂ + Feβ + | 1.8 | 89 | 60 |
| | Pt—Fe | | | |
| | composite oxide | | | |
| Catalyst 24 | Pt/CeO₂•ZrO₂ +Cuβ + | 1.8 | 89 | 59 |
| | Pt—Fe | | | |
| | composite oxide | | | |
| Catalyst 25 | Pt/TiO₂ + Feβ + | 1.8 | 88 | 58 |
| | Pt—Fe | | | |
| | composite oxide | | | |
| Comparative | Pt/Al₂O₃ + HY | 1.8 | 93 | 25 |
| Catalyst 1 | | | | |
| Comparative | Pt/Al₂O₃ + HY | 0.8 | 88 | <10 |
| Catalyst 2 | | | | |
| Comparative | Pt/ZrO₂ | 1.8 | 93 | <10 |
| Catalyst 3 | | | | |
| Comparative | Pt/Al₂O₃ | 1.8 | 92 | <10 |
| Catalyst 4 | | | | |
| Comparative | Feβ | | 43 | <10 |
| Catalyst 7 | | | | |
| Comparative | Cuβ | | 38 | <10 |
| Catalyst 8 | | | | |

Notes:
The values next to Pt described in component 1 + component 2 in the table represent the Pt content (g/L) of the catalyst per liter of the catalyst support.

### Example 2

### Example of Organosilicon Compound Poisoning Test on Pt/Al₂O₃+Feβ+Pt—Fe Composite Oxide-Containing Catalysts with Fe/(Pt+Fe) Atomic Ratio of Pt—Fe Composite Oxide Changed

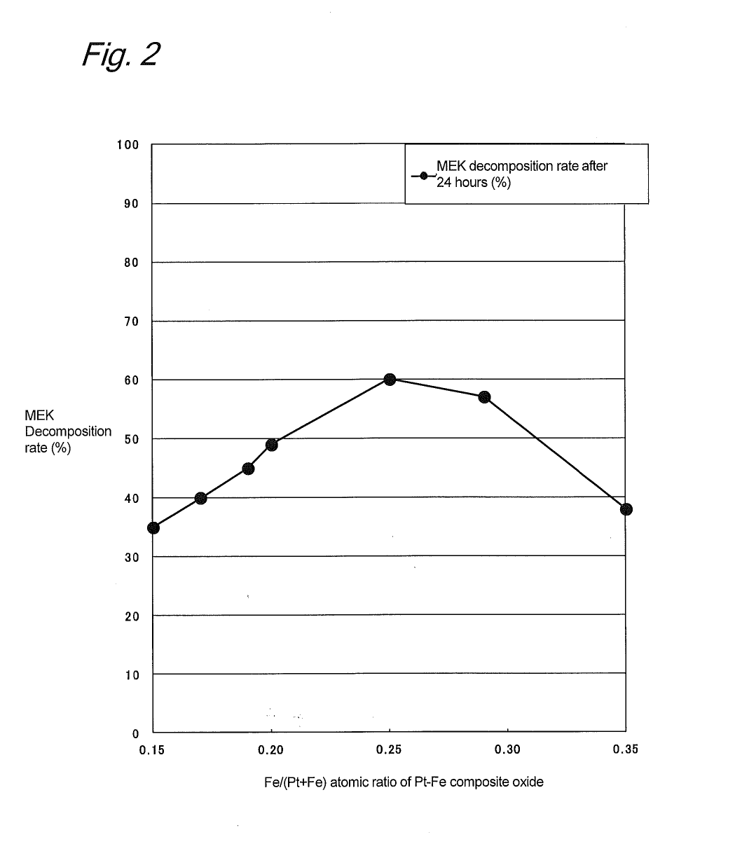

Table 5 and FIG. 2 show the test results on the catalysts 1, 2, 3 and 4 having Pt—Fe forming the composite oxide, but different in the atomic ratio of Pt and Fe (Fe/(Pt+Fe)), in the test of the same contents as in Example 1. The atomic ratio for formation of the Pt—Fe composite oxide, (Fe/(Pt+Fe)), was preferably in the range of 0.17 to 0.3, more preferably 0.20 to 0.30, thereby achieving the MEK decomposition rate, after 24 hours, of 40% or more.

TABLE 5

| | | Fe(Pt + Fe) | Pt content | | |
|---|---|---|---|---|---|
| | | atomic ratio | in catalyst | MEK | MEK |
| | | of Pt—Fe | (g/liter of | decomposition | decomposition |
| Catalyst | Catalyst | composite | catalyst | rate (%) | rate (%) |
| name | composition | oxide | support) | At start | After 24 hours |
| Catalyst 1 | Pt/Al₂O₃ + Feβ + | 0.25 | 1.8 | 88 | 60 |
| | Pt—Fe | | | | |
| | composite oxide | | | | |
| Catalyst 2 | Pt/Al₂O₃ + Feβ + | 0.29 | 1.8 | 87 | 57 |
| | Pt—Fe | | | | |
| | composite oxide | | | | |
| Catalyst 3 | Pt/Al₂O₃ + Feβ + | 0.35 | 1.8 | 86 | 38 |
| | Pt—Fe | | | | |
| | composite oxide | | | | |
| Catalyst 4 | Pt/Al₂O₃ + Feβ + | 0.17 | 1.8 | 87 | 40 |
| | Pt—Fe | | | | |
| | composite oxide | | | | |
| Catalyst 5 | Pt/Al₂O₃ + Feβ + | 0.20 | 1.8 | 86 | 49 |
| | Pt—Fe | | | | |
| | composite oxide | | | | |
| Catalyst 6 | Pt/Al₂O₃ + Feβ + | 0.19 | 1.8 | 87 | 45 |
| | Pt—Fe | | | | |
| | composite oxide | | | | |
| Catalyst 7 | Pt/Al₂O₃ + Feβ + | 0.15 | 1.8 | 85 | 35 |
| | Pt—Fe | | | | |
| | composite oxide | | | | |

### Example 3

### Example of Organosilicon Compound Poisoning Test Involving Change in Ratio of Atomic Number of Pt not Forming Pt—Fe Composite Oxide to Total Atomic Number of Pt not Forming Pt—Fe Composite Oxide and Pt of Pt—Fe Composite Oxide in Each Catalyst Prepared

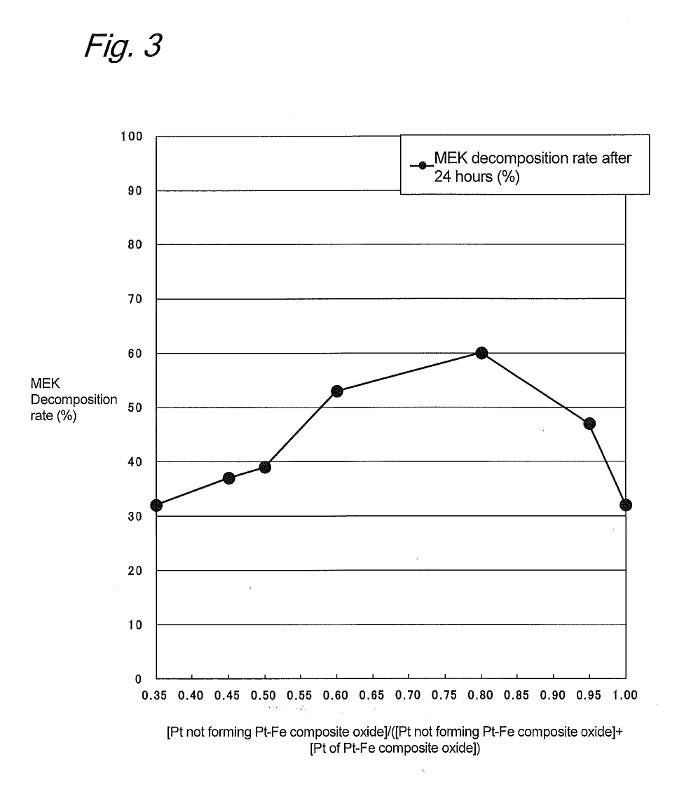

The ratio of the atomic number of the Pt not forming the Pt—Fe composite oxide to the total atomic number of the Pt not forming the Pt—Fe composite oxide and the Pt of the Pt—Fe composite oxide (i.e. [Pt]/([Pt]+[Pt of Pt—Fe composite oxide])) was preferably in the range of 0.50 to 0.95, more preferably 0.50 to 0.90, thereby achieving the MEK decomposition rate, after 24 hours, of 45% or more. Reference to Table 6 below and FIG. 3 is requested.

TABLE 6

| | | Ratio⁽¹⁾ of atomic number | | | |
|---|---|---|---|---|---|
| | | of Pt not forming Pt—Fe | | | |
| | | composite oxide to total | Pt content | | |
| | | atomic number of Pt not | in catalyst | MEK | MEK |
| | | forming Pt—Fe composite | (g/liter of | decomposition | decomposition |
| Catalyst | Catalyst | oxide and Pt of Pt—Fe | catalyst | rate (%) | rate (%) |
| name | composition | composite oxide | support) | At start | After 24 hours |
| Catalyst 1 | Pt/Al₂O₃ + Feβ + | 0.8 | 1.8 | 88 | 60 |
| | Pt—Fe | | | | |
| | composite oxide | | | | |
| Catalyst 8 | Pt/Al₂O₃ + Feβ + | 0.5 | 1.8 | 78 | 39 |
| | Pt—Fe | | | | |
| | composite oxide | | | | |
| Catalyst 9 | Pt/Al₂O₃ + Feβ + | 0.6 | 1.8 | 86 | 53 |
| | Pt—Fe | | | | |
| | composite oxide | | | | |
| Catalyst 10 | Pt/Al₂O₃ + Feβ + | 0.95 | 1.8 | 89 | 47 |
| | Pt—Fe | | | | |
| | composite oxide | | | | |
| Catalyst 11 | Pt/Al₂O₃ + Feβ + | 0.45 | 1.8 | 76 | 37 |
| | Pt—Fe | | | | |
| | composite oxide | | | | |
| Catalyst 12 | Pt/Al₂O₃ + Feβ + | 0.35 | 1.8 | 74 | 32 |
| | Pt—Fe | | | | |
| | composite oxide | | | | |
| Reference | Pt/Al₂O₃ + Feβ | 1 | 1.8 | 90 | 32 |
| Catalyst 1 | | | | | |

Notes:
⁽¹⁾represents [Pt not forming Pt—Fe composite oxide]/([Pt not forming Pt—Fe composite oxide] + [Pt of Pt—Fe composite oxide])

### Example 4

### Example of Organosilicon Compound Poisoning Test in which Fe/(Pt+Fe) Atomic Ratio of Pt—Fe Composite Oxide was Fixed at 0.25 and Pt Average Particle Diameter of Pt/Al₂O₃+Fep+Pt—Fe Composite Oxide-Containing Catalyst was Changed

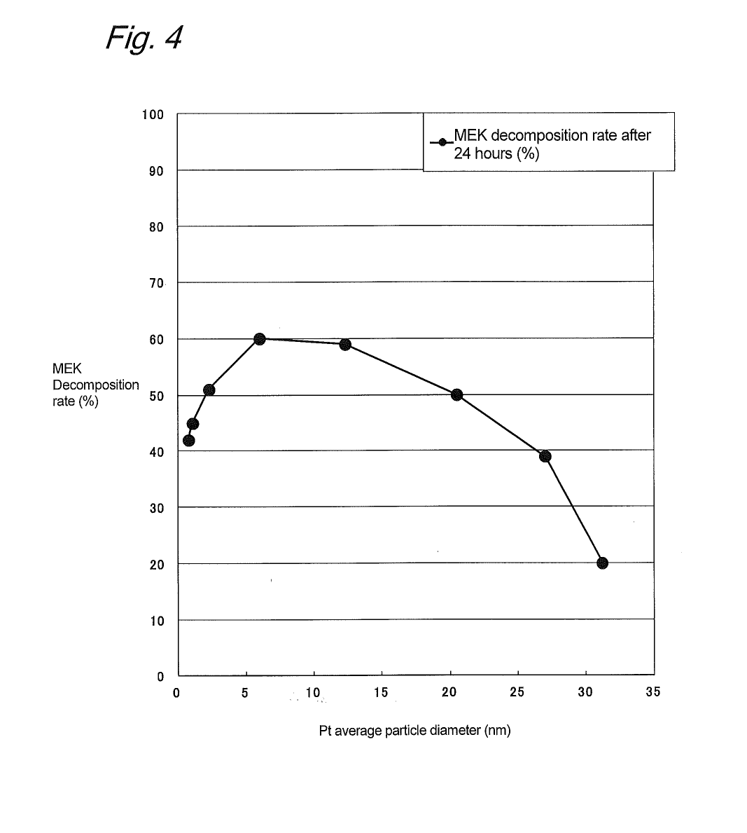

By setting the average particle diameter of Pt in the range of 0.8 to 25 nm, the MEK decomposition rate, after 24 hours, of 40% or more was achieved, and the durability of the catalyst against organosilicon compound poisoning was improved. See Table 7 below and FIG. 4.

TABLE 7

| | | | Pt | | |
|---|---|---|---|---|---|
| | | Pt content | average | MEK | MEK |
| | | in catalyst | particle | decomposition | decomposition |
| Catalyst | Catalyst | (g/liter of | diameter | rate (%) | rate (%) |
| name | composition | catalyst support) | nm | At start | After 24 hours |
| Catalyst 1 | Pt/Al₂O₃ + Feβ + | 1.8 | 6 | 88 | 60 |
| | Pt—Fe | | | | |
| | composite oxide | | | | |
| Catalyst 13 | Pt/Al₂O₃ + Feβ + | 1.8 | 1.1 | 85 | 45 |
| | Pt—Fe | | | | |
| | composite oxide | | | | |
| Catalyst 14 | Pt/Al₂O₃ + Feβ + | 1.8 | 2.3 | 90 | 51 |
| | Pt—Fe | | | | |
| | composite oxide | | | | |
| Catalyst 15 | Pt/Al₂O₃ + Feβ + | 1.8 | 12.3 | 91 | 59 |
| | Pt—Fe | | | | |
| | composite oxide | | | | |
| Catalyst 16 | Pt/Al₂O₃ + Feβ + | 1.8 | 20.5 | 87 | 50 |
| | Pt—Fe | | | | |
| | composite oxide | | | | |
| Catalyst 17 | Pt/Al₂O₃ + Feβ + | 1.8 | 31.2 | 86 | 20 |
| | Pt—Fe | | | | |
| | composite oxide | | | | |
| Catalyst 18 | Pt/Al₂O₃ + Feβ + | 1.8 | 0.8 | 86 | 42 |
| | Pt—Fe | | | | |
| | composite oxide | | | | |
| Catalyst 19 | Pt/Al₂O₃ + Feβ + | 1.8 | 27 | 87 | 39 |
| | Pt—Fe | | | | |
| | composite oxide | | | | |

Exhaust Gas Treatment Test 2 (H₂S Poisoning Test)

Each of the catalysts was charged into a reactor (vertical flow apparatus), and a gas containing H₂S was flowed through the reactor for 14 hours to conduct an exhaust gas treatment test. The test was performed by flowing the exhaust gas through the reactor at a gas space velocity (SV) of 50,000 hr⁻¹, while maintaining the catalyst layer at 230° C., and analyzing the composition of the gas exiting from the reactor. Herein, the flow rate of the exhaust gas divided by the volume of the support was taken as the SV. The MEK concentration (C1) and the H₂S concentration in the exhaust gas before treatment were measured by sampling the gas at the inlet of the reactor, while the MEK concentration in the exhaust gas after treatment (C2) was measured by sampling the gas at the outlet of the reactor.

The composition of the exhaust gas flowed through the reactor was as follows:

Methyl ethyl ketone (MEK): 500 ppm

H₂S: 10 ppm as [S]

Water: 2, vol. %

Air: Remainder

The MEK decomposition rate was calculated from the following equation, as was in the exhaust gas treatment test 1 (organosilicon compound poisoning test at 230° C.)

MEK decomposition rate(%)=100×(C1−C2)/C1

(where C1 is the MEK concentration at the inlet of the reactor, and C2 is the MEK concentration at the outlet of the reactor.)

(Test Results)

The MEK decomposition rates 14 hours after the test (exhaust gas treatment test 2) in which the exhaust gas containing H₂S was flowed through the catalysts 1 and 17, the catalysts of the present invention, and the comparative catalysts 1, 4 and 5, the catalysts of the comparative examples, are shown.

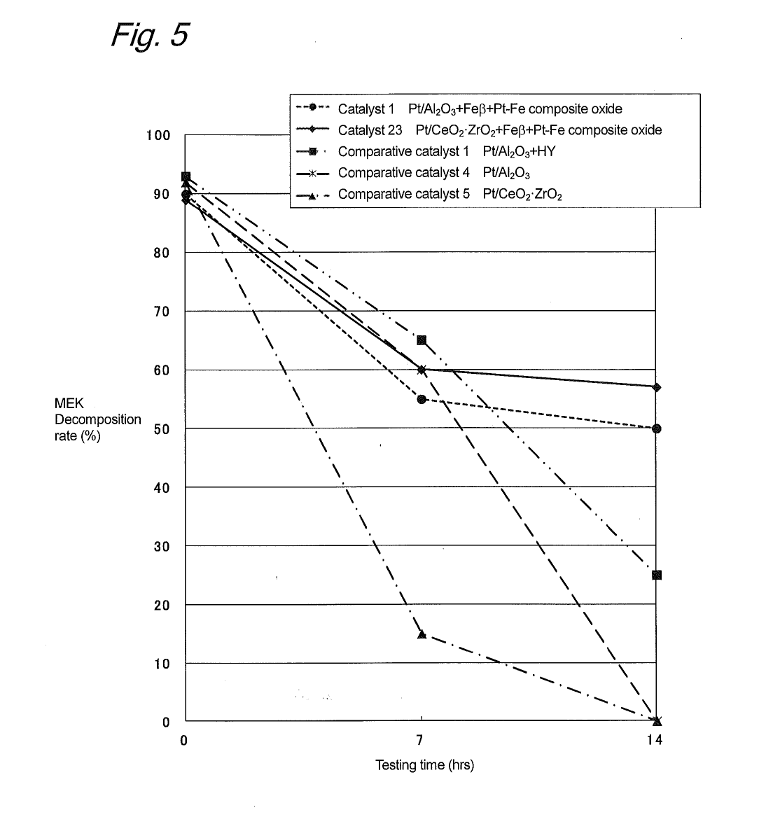

The MEK decomposition performances after 14 hours in the catalysts 1 and 17 were 50% and 58%, respectively. The MEK decomposition performances after 14 hours in the comparative catalysts 1, 4 and 5 were 25%, <10% and <10%, respectively. These findings demonstrate the catalysts of the present invention to have excellent effects with markedly improved durability against H₂S poisoning. See Table 8 below and FIG. 5.

TABLE 8

| | | Pt content | MEK | MEK |
|---|---|---|---|---|
| | | in catalyst | decomposition | decomposition |
| Catalyst | Catalyst | (g/liter of | rate (%) | rate (%) |
| name | composition | catalyst support) | At start | After 14 hours |
| Catalyst 1 | Pt/Al₂O₃ + Feβ + | 1.8 | 90 | 50 |
| | Pt—Fe | | | |
| | composite oxide | | | |
| Catalyst 17 | Pt/CeO₂•ZrO₂ + | 1.8 | 90 | 58 |
| | Feβ + Pt—Fe | | | |
| | composite oxide | | | |
| Comparative | Pt/Al₂O₃ + HY | 1.8 | 93 | 25 |
| Catalyst 1 | | | | |
| Comparative | Pt/Al₂O₃ | 1.8 | 92 | <10 |
| Catalyst 4 | | | | |
| Comparative | Pt/CeO₂—ZrO₂ | 1.8 | 92 | <10 |
| Catalyst 5 | | | | |

1. A catalyst composition for purifying an exhaust gas containing an organic compound, the catalyst composition comprising;
at least one inorganic oxide (component 1) selected from the group consisting of alumina, zirconia, titania, silica, ceria, and ceria-zirconia, each having a noble metal supported thereon;
β zeolite (component 2) having supported thereon at least one metal selected from the group consisting of Fe, Cu, Co and Ni; and
a Pt—Fe composite oxide (component 3).

2. The catalyst composition according to claim 1, wherein a ratio of an atomic number of Fe to a total atomic number of the Pt and Fe of the Pt—Fe composite oxide, ([Fe]/([Pt]+[Fe])), is 0.17 to 0.3.

3. The catalyst composition according to claim 1, wherein the noble metal is Pt, and the ratio of the atomic number of the Pt not forming the Pt—Fe composite oxide to the total atomic number of the Pt not forming the Pt—Fe composite oxide and the Pt of the Pt—Fe composite oxide is 0.50 to 0.95.

4. The catalyst composition according to claim 3, wherein the Pt has a valence of 0 or 2, and the Pt has an average particle diameter of 0.8 to 25 nm.

5. The catalyst composition according to claim 3, wherein a content of the Pt is 0.1% by weight to 10% by weight based on the component 1.

6. The catalyst composition according to claim 1, wherein a weight ratio between the component 1 and the component 2 is 1:9 to 9:1, and an SiO₂/Al₂O₃ molar ratio of the 13 zeolite as the component 2 is 5 or more, but 100 or less.

7. The catalyst composition according to claim 1, further comprising a binder.

8. The catalyst composition according to claim 1, wherein the noble metal supported on the component 1 is Pt, Pd, Rh, Ir, Ru, Os, an alloy thereof, or a mixture thereof.

9. A catalyst for purifying an exhaust gas containing an organic compound, the catalyst comprising:
a catalyst support; and
a catalyst layer formed on the catalyst support and containing the catalyst composition according to claim 1.

10. The catalyst composition according to claim 2, wherein the noble metal is Pt, and the ratio of the atomic number of the Pt not forming the Pt—Fe composite oxide to the total atomic number of the Pt not forming the Pt—Fe composite oxide and the Pt of the Pt—Fe composite oxide is 0.50 to 0.95.

11. The catalyst composition according to claim 4, wherein a content of the Pt is 0.1% by weight to 10% by weight based on the component 1.

12. The catalyst composition according to claim 2, wherein a weight ratio between the component 1 and the component 2 is 1:9 to 9:1, and an SiO₂/Al₂O₃ molar ratio of the β zeolite as the component 2 is 5 or more, but 100 or less.

13. The catalyst composition according to claim 3, wherein a weight ratio between the component 1 and the component 2 is 1:9 to 9:1, and an SiO₂/Al₂O₃ molar ratio of the β zeolite as the component 2 is 5 or more, but 100 or less.

14. The catalyst composition according to claim 4, wherein a weight ratio between the component 1 and the component 2 is 1:9 to 9:1, and an SiO₂/Al₂O₃ molar ratio of the β zeolite as the component 2 is 5 or more, but 100 or less.

15. The catalyst composition according to claim 5, wherein a weight ratio between the component 1 and the component 2 is 1:9 to 9:1, and an SiO₂/Al₂O₃ molar ratio of the β zeolite as the component 2 is 5 or more, but 100 or less.

16. A catalyst for purifying an exhaust gas containing an organic compound, the catalyst comprising:
a catalyst support; and
a catalyst layer formed on the catalyst support and containing the catalyst composition according to claim 2.

17. A catalyst for purifying an exhaust gas containing an organic compound, the catalyst comprising:
a catalyst support; and
a catalyst layer formed on the catalyst support and containing the catalyst composition according to claim 3.

18. A catalyst for purifying an exhaust gas containing an organic compound, the catalyst comprising:
a catalyst support; and
a catalyst layer formed on the catalyst support and containing the catalyst composition according to claim 4.

19. A catalyst for purifying an exhaust gas containing an organic compound, the catalyst comprising:
a catalyst support; and
a catalyst layer formed on the catalyst support and containing the catalyst composition according to claim 5.

20. A catalyst for purifying an exhaust gas containing an organic compound, the catalyst comprising:
a catalyst support; and
a catalyst layer formed on the catalyst support and containing the catalyst composition according to claim 6.
